(19) United States
(12) Patent Application Publication
(10) Pub. No.: US 2010/0138300 A1
(43) Pub. Date: Jun. 3, 2010

(54) METHOD AND APPARATUS FOR PROMOTING PRODUCTS OR SERVICES

(75) Inventor: R. TYLER WALLIS, Dallas, TX (US)

Correspondence Address: AT&T Legal Department - GMG;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/326,660

(22) Filed: Dec. 2, 2008

(51) Int. Cl. G06Q 30/00

(52) U.S. Cl. 705/14.58

(57) ABSTRACT

A system that incorporates teachings of the present disclosure may include, for example, a system having a controller to receive an acceptance from a user to opt into an advertisement program, receive from the user a plurality of calendar events associated with personal information of the user, share the plurality of calendar events with a plurality of advocates, receive from the plurality of advocates a corresponding plurality of advertisements, each advertisement indicating an association with one of the plurality of calendar events, and transmit to a communication device of the user the plurality of advertisements for updating the plurality of calendar events at the communication device. Other embodiments are disclosed.

### FIELD OF THE DISCLOSURE

The present disclosure relates generally to communication techniques and more specifically to a method and apparatus for promoting products or services.

### BACKGROUND

There are many techniques for promoting products or services. A few examples include TV advertisements, newspaper advertisements, magazine advertisements, advertisements by way of email or regular mail distributions, and on-line portals. Some merchants seek the services of marketing organizations to perform market surveys and focus group studies to assist them in honing in on product or service features and demographic target groups. This research can be helpful to a merchant prior to investing in an advertisement campaign.

### BRIEF DESCRIPTION OF THE DRAWINGS

FIGS. 1-2 depict illustrative embodiments of communication systems that provide media services;

FIG. 3 depicts an illustrative embodiment of a portal interacting with the communication systems of FIGS. 1-2;

FIG. 4 depicts an illustrative embodiment of a communication device utilized in the communication systems of FIGS. 1-2;

FIG. 5 depicts an illustrative embodiment of a method according to the present disclosure;

FIGS. 6-7 depict illustrative embodiments of the method of FIG. 5; and

FIG. 8 is a diagrammatic representation of a machine in the form of a computer system within which a set of instructions, when executed, may cause the machine to perform any one or more of the methodologies discussed herein.

### DETAILED DESCRIPTION

One embodiment of the present disclosure can entail a system having a controller to receive an acceptance from a user to opt into an advertisement program, receive from the user a plurality of calendar events associated with personal information of the user, share the plurality of calendar events with a plurality of advocates, receive from the plurality of advocates a corresponding plurality of advertisements, each advertisement indicating an association with one of the plurality of calendar events, and transmit to a communication device of the user the plurality of advertisements for updating the plurality of calendar events at the communication device.

Another embodiment of the present disclosure can entail a communication device having a controller to record a plurality of calendar events and receive a plurality of advertisements, each advertisement directed to one of the plurality of calendar events. The plurality of calendar events can be shared with one or more advocates. The one or more advocates can in turn generate the plurality of advertisements according to subject matter in the shared plurality of calendar events. The controller can also be adapted to identify associations between the plurality of advertisements and the plurality of calendar events, and update the recorded plurality of calendar events with the plurality of advertisements according to the identified associations.

Yet another embodiment of the present disclosure can entail promoting a product or service by way of a calendar operating in a communication device of a party. The party shares a plurality of calendar events with an advocate of the product or service.

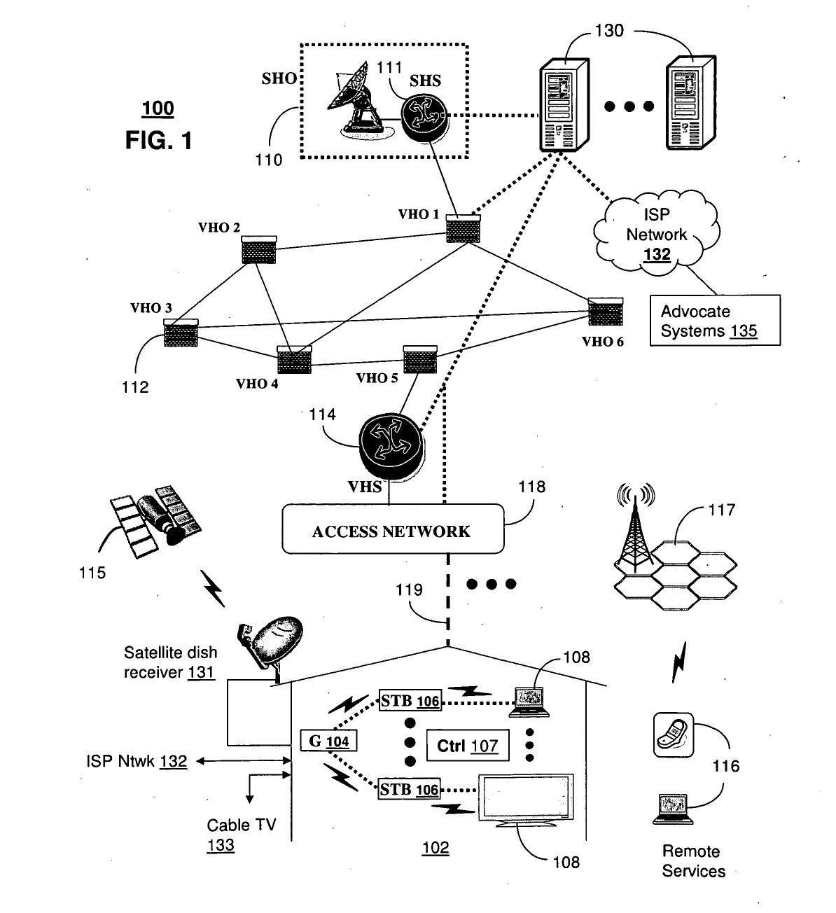

FIG. 1 depicts an illustrative embodiment of a first communication system 100 for delivering media content. The communication system 100 can represent an Internet Protocol Television (IPTV) broadcast media system. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to video head-end servers (VHS) 114 via a network of video head-end offices (VHO) 112 according to a common multicast communication protocol.

The VHS 114 can distribute multimedia broadcast programs via an access network 118 to commercial and/or residential buildings 102 housing a gateway 104 (such as a common residential or commercial gateway). The access network 118 can represent a group of digital subscriber line access multiplexers (DSLAMs) located in a central office or a service area interface that provide broadband services over optical links or copper twisted pairs to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

Another distinct portion of the computing devices can function as a promotion management system (herein referred to as a promotion management system 130). The promotion management system (PMS) 130 can manage promotions supplied by advocate systems 135 operated by merchants or brokers who market products and services. The advocate systems 135 can utilize common computing and communication technologies to distribute promotional materials to the PMS 130.

Promotional materials can be represented by electronic advertisements that can be distributed to the PMS 130 in the form of coupons, discount codes, or other promotional subject matter which can be used to purchase a particular product or service. Some advocate systems 135 can also be programmed to offer a means to bid on a product or service, or allow for reverse bids.

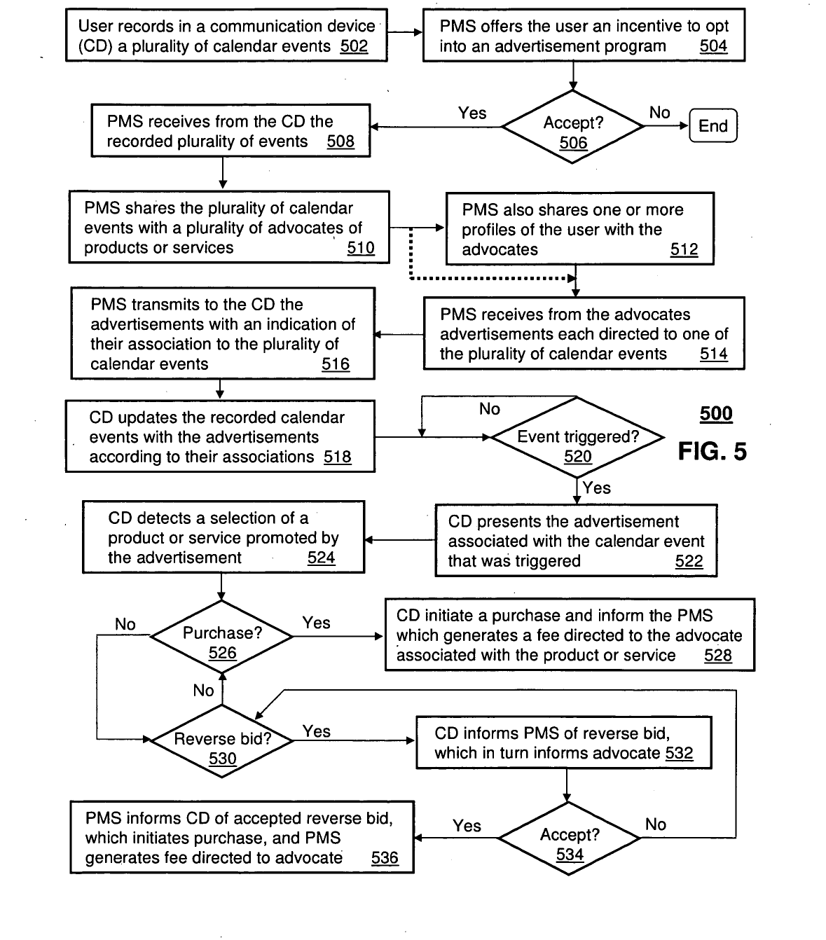

The PMS 130 can offer users of communication system 100 of FIG. 1 an opt-in advertisement program with incentives for users who share personal information with the advocate systems 135. The incentives can include discounted services provided by the communication system 100 of FIG. 1. The incentives can also be in the form of discounted products or services offered through the advertisement program. Additional details about the PMS 130 and the advocate systems 135 are described in the illustrative embodiments of FIG. 5.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services.

It follows from the above illustrations that the present disclosure can apply to any present or future interactive media content services.

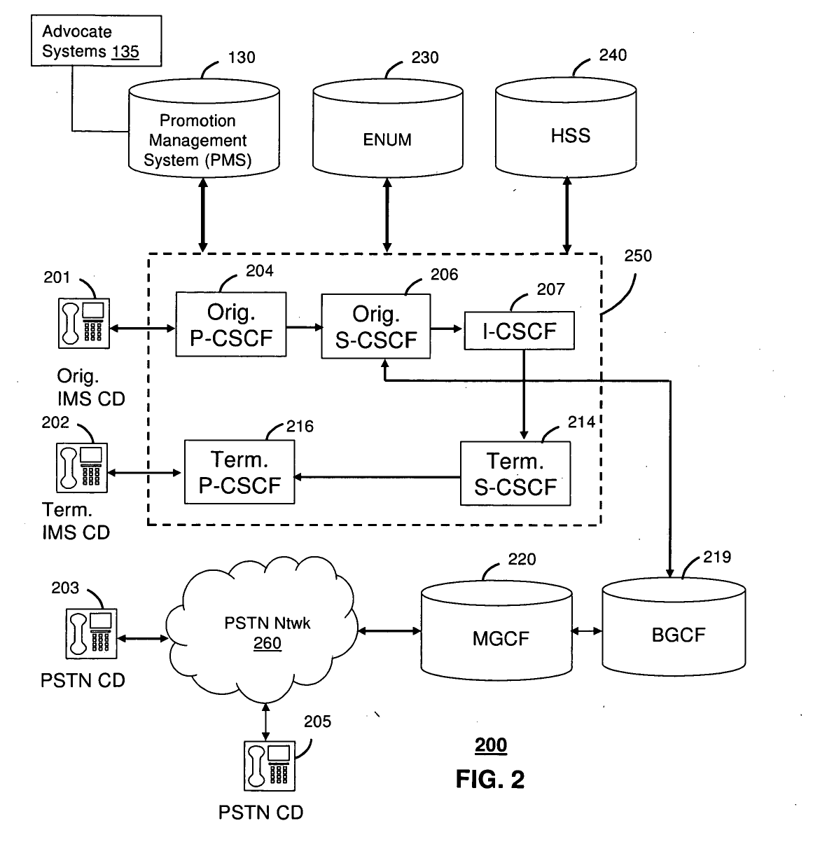

FIG. 2 depicts an illustrative embodiment of a communication system 200 employing an IP Multimedia Subsystem (IMS) network architecture to facilitate the combined services of circuit-switched and packet-switched systems. Communication system 200 can be overlaid or operably coupled with communication system 100 as another representative embodiment of communication system 100.

Communication system 200 can comprise a Home Subscriber Server (HSS) 240, a tElephone NUmber Mapping (ENUM) server 230, and other common network elements of an IMS network 250. The IMS network 250 can establish communications between IMS compliant communication devices (CD) 201, 202, Public Switched Telephone Network (PSTN) CDs 203, 205, and combinations thereof by way of a Media Gateway Control Function (MGCF) 220 coupled to a PSTN network 260.

IMS CDs 201, 202 can register with the IMS network 250 by contacting a Proxy Call Session Control Function (P-CSCF) which communicates with a corresponding Serving CSCF (S-CSCF) to register the CDs with at the HSS 240. To initiate a communication session between CDs, an originating IMS CD 201 can submit a Session Initiation Protocol (SIP INVITE) message to an originating P-CSCF 204 which communicates with a corresponding originating S-CSCF 206. The originating S-CSCF 206 can submit queries to the ENUM system 230 to translate an E. 164 telephone number in the SIP INVITE to a SIP Uniform Resource Identifier (URI) if the terminating communication device is IMS compliant.

The SIP URI can be used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214. The terminating S-CSCF 214 can then identify a terminating P-CSCF 216 associated with the terminating CD 202. The P-CSCF 216 then signals the CD 202 to establish communications.

If the terminating communication device is instead a PSTN CD such as references 203 or 205, the ENUM system 230 can respond with an unsuccessful address resolution which can cause the originating S-CSCF 206 to forward the call to the MGCF 220 via a Breakout Gateway Control Function (BGCF) 219. The MGCF 220 can then initiate the call to the terminating PSTN CD by common means over the PSTN network 260.

The aforementioned communication process is symmetrical. Accordingly, the terms “originating” and “terminating” in FIG. 2 are interchangeable. It is further noted that communication system 200 can be adapted to support video conferencing by way of common protocols such as H.323. In addition, communication system 200 can be adapted to provide the IMS CDs 201, 203 the multimedia and Internet services of communication system 100.

The PMS 130 of FIG. 1 can be operably coupled to the second communication system 200 for purposes similar to those described above.

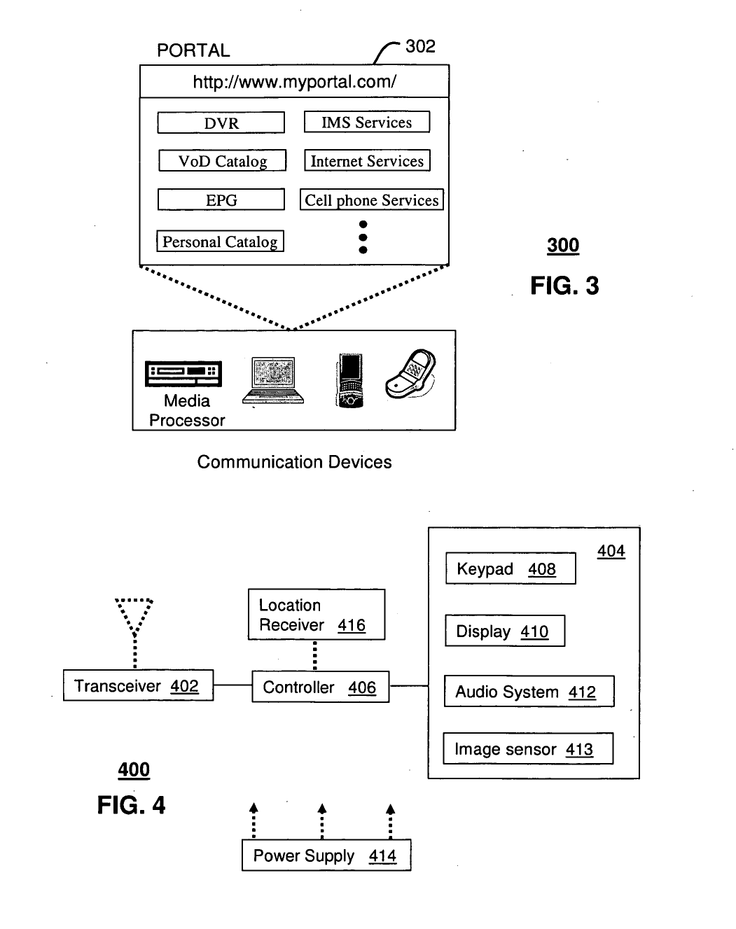

FIG. 3 depicts an illustrative embodiment of a portal 302 which can operate from the computing devices 130 described earlier of communication 100 illustrated in FIG. 1. The portal 302 can be used for managing services of communication systems 100-200. The portal 302 can be accessed by a Uniform Resource Locator (URL) with a common Internet browser such as Microsoft's Internet Explorer™ using an Internet-capable communication device such as those described for FIGS. 1-2. The portal 302 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services described earlier, provisioning Internet services, provisioning cellular phone services, and so on.

FIG. 4 depicts an exemplary embodiment of a communication device 400. Communication 400 can serve in whole or in part as an illustrative embodiment of the communication devices of FIGS. 1-2. The communication device 400 can comprise a wireline and/or wireless transceiver 402 (herein transceiver 402), a user interface (UI) 404, a power supply 414, a location receiver 416, and a controller 406 for managing operations thereof. The transceiver 402 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 402 can also be adapted to support circuit-switched wireline access technologies (such as PSTN), packet-switched wireline access technologies (such as TCPIP, VoIP, etc.), and combinations thereof.

The UI 404 can include a depressible or touch-sensitive keypad 408 with a navigation mechanism such as a roller ball, joystick, mouse, or navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth. The keypad 408 can represent a numeric dialing keypad commonly used by phones, and/or a Qwerty keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display.

The UI 404 can also include an audio system 412 that utilizes common audio technology for conveying low volume audio (such as audio heard only in the proximity of a human ear) and high volume audio (such as speakerphone for hands free operation). The audio system 412 can further include a microphone for receiving audible signals of an end user. The UI 404 can further include an image sensor 413 such as a charged coupled device (CCD) camera for capturing still or moving images.

The power supply 414 can utilize common power management technologies such as replaceable and rechargeable batteries, supply regulation technologies, and charging system technologies for supplying energy to the components of the communication device 400 to facilitate long-range or short-range portable applications. The location receiver 416 can utilize common location technology such as a global positioning system (GPS) receiver for identifying a location of the communication device 100 based on signals generated by a constellation of GPS satellites, thereby facilitating common location services such as navigation. The controller 406 can utilize computing technologies such as a microprocessor, a digital signal processor (DSP), and/or a video processor with associated storage memory such a Flash, ROM, RAM, SRAM, DRAM or other storage technologies.

The communication device 400 can be adapted to perform the functions of the media processor 106, the media devices 108, or the portable communication devices 116 of FIG. 1, as well as the IMS CDs 201-202 and PSTN CDs 203-205 of FIG. 2. It will be appreciated that the communication device 400 can also represent other common devices that can operate in communication systems 100-200 of FIGS. 1-2 such as a gaming console and a media player.

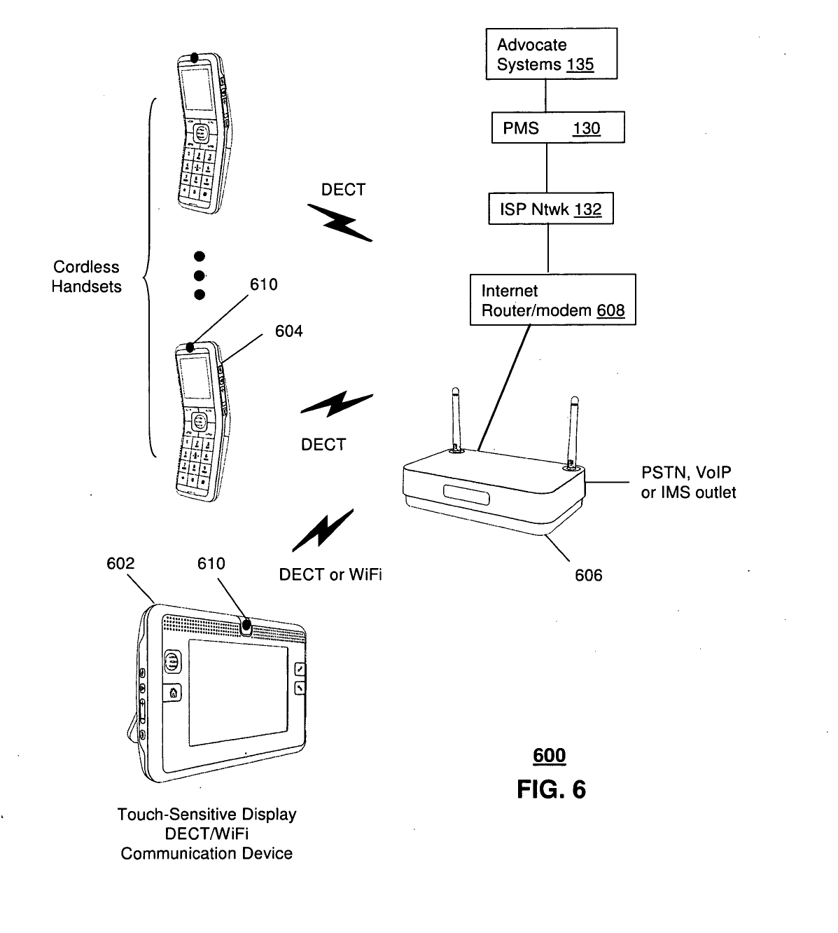

FIG. 5 depicts an illustrative method 500 for promoting products or services. FIG. 6 depicts an illustrative embodiment of a block diagram 600 of communication devices operating according to method 500. Block diagram 600 comprises a communication device 602 in the form of a tablet with a touch-sensitive display (herein referred to as tablet 602). The tablet 602 can include communication technology to support both DECT and WiFi protocols. The tablet 602 can be communicatively coupled to a base unit 606 by way of the DECT and WiFi air interfaces. A plurality of cordless handsets 604 can also be communicatively coupled to the base unit 606 using the DECT protocol.

The base unit 606 can include communication technology for communicatively interfacing to a PSTN, VoIP or IMS network such as those described earlier. The base unit 606 can be coupled to an Internet/router modem 608 for communicatively interfacing to the PMS 130 and the advocate systems 130 by way of the ISP network 132 of FIG. 1. The base unit 606 can provide the cordless handsets voice communication services, and the tablet 602 a combination of voice and data communication services. The tablet 602 and cordless handsets 604 can be equipped with common camera sensors 610 (such as charged coupled device sensors) which can enable these devices to support video communication services.

With the configuration of FIG. 6 in mind, method 500 can begin with step 502 in which a user of one of the communication devices of FIG. 6 records a plurality of calendar events. For illustration purposes only the communication device chosen by the user in step 502 will be assumed to be the tablet 602. The calendar events can be recorded in a calendar application such as Microsoft Outlook™, a derivative thereof, or other common calendar applications. The plurality of calendar events can also be recorded in an address book for each party entry. For example, an address book entry for Sam Doe can include phone numbers (home, office, mobile), email addresses (work, personal), and specific calendar events of interest (e.g., birthday of Sam Doe, birthdays of Sam Doe's spouse and children, Sam Doe's wedding anniversary, and so on). The calendar events entered in the address book can be linked to the calendar application mentioned above.

In step 504, the PMS 130 can be programmed to offer the user of the tablet 602 an incentive to opt into an advertisement program. The incentive can be a service discount or discounts of products or services promoted by the advocate systems 135. The offer can be presented to the user by way of the tablet 602 over a browser connection to the portal 302, by way of an email message, or by other suitable forms of messaging. The message from the PMS 130 can describe the terms of the advertisement program. The terms can for example require that the user disclose personal information recorded in the calendar and/or address book operating in the tablet 602. The email message can also include a hyperlink which if selected by the user in step 506 can cause the tablet 602 to transmit a signal (e.g., HTML signal) to the PMS 130 indicating that the user has accepted the offer. Once an acceptance is detected by any common communication means, the PMS 130 can automatically download an application to the tablet 602 (such as an active X application and additional software performing the functions described herein) to initiate the advertisement program.

The downloaded application operating in the tablet 602 can scan the user's calendar and address book applications for entries concerning personal data of the user and parties associated with the user. For example, the application can search for entries in the address book associated with birthdays and anniversaries of parties associated with the user. The parties can include the user himself, a sibling of the user, a parent of the user, a spouse of the user, a child of the user, a grandchild of the user, a friend of the user or anyone else who may have an association with the user. The downloaded application can also extract from the address book personal data of the parties including without limitation age, gender, city of residence, and so on.

The application can also search for planned events such dinner engagements and vacations. When the application locates a calendar event in the calendar application it can also retrieve a description of the event and any merchants associated with the event. For example, in the case of a scheduled dinner event, the application can locate the name of the restaurant, the parties participating in the event, and the location of the restaurant if given. Similarly, calendar events associated with vacation plans can be retrieved by the application. The application can extract from a description of the vacation the general location of the planned vacation (e.g., Beaver Creek, Colo.), identify a vacation type (e.g., ski vacation), and the hotel where the user and his/her family or friends plan to stay.

Once the scanning process is completed, the application can direct the tablet 602 to transmit the collected data to the PMS 130 in step 508. The PMS 130 can pre-process the information before it is submitted to the advocate systems 135. For example, the PMS 130 can organize calendar events collected by the application described above into categories such as birthdays, anniversaries, restaurant engagements, and scheduled vacations. Once the calendar events have been categorized, the PMS 130 can determine which of the advocate systems 130 can potentially serve the needs of the user according to known products or services promoted by these systems, and in step 510 transmit the categorized calendar events according to the identified advocate systems 135.

To assist the advocate systems 135 in performing targeted advertising, the PMS 130 can share one or more profiles of the user with these systems. The profiles can include a demographic profile, psychographic profile, or a behavioral profile. The demographic profile of the user (which can be determined from subscriber account information held by the service provider of the communication systems 100-200 of FIGS. 1-2) can describe the user's age, gender, city where the user lives, income range, education, number of residents in the user's household, and so on. The psychographic profile can describe traits, attitudes, interests, and/or lifestyles of the user. The psychographic profile can be determined by the PMS 130 with common tools that analyze the media consumption behavior of the user in the communication systems 100-200. The behavioral profile can be a collective description of the demographic and psychographic profiles of the user.

With the calendar events and user profiles supplied by the PMS 130, the advocate systems 135 can utilize common marketing analysis tools to identify advertisements in their promotional databases that can potentially satisfy the needs or interests of the user. Each of the advertisements identified by the advocate systems 135 can be tagged with metadata in order to associate the advertisements to the calendar events supplied by the user's tablet 602. In step 514, the PMS 130 can receive from the advocate systems 135 the advertisements with the metadata, which the PMS can transmit in step 516 the to the tablet 602. The tablet 602 can be programmed in step 518 to update the recorded calendar events according to the metadata of each advertisement. The metadata can for example identify a calendar event by date and time with an identification of the advertisement to be added to the identified calendar event. After completing this step, the updated calendar events would include the advertisements received from the PMS 130.

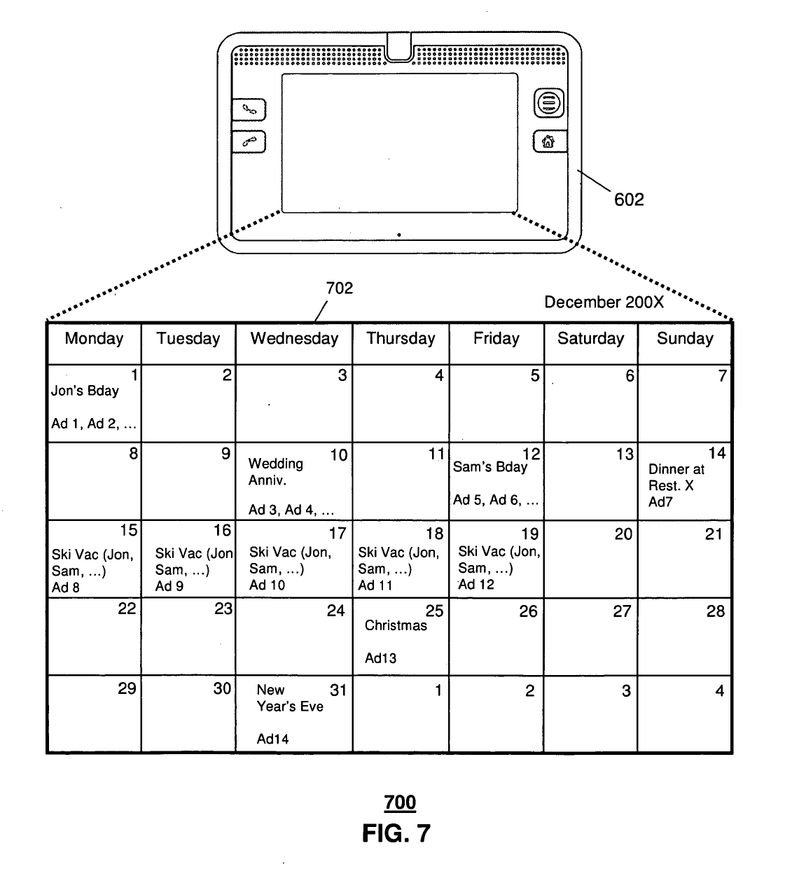

When a calendar event is triggered in step 520, the tablet 602 can be programmed to present in step 522 a description of the event along with one or more selectable advertisements supplied by the PMS 130. FIG. 7 depicts an illustration of updated calendar events 702 and associated advertisements for the month of December. In this illustration, Jon's birthday has two advertisements (Ad1 and Ad2). Ads 1 and 2 can be selected by the advocate systems 135 based on information about Jon provided by the downloaded application described earlier. For example, the address book application in the tablet 602 may have an entry for Jon indicating that Jon is a male, born MM/DD/YY making him a teenager and freshman in high school, and is a cousin of the user.

With this information, the advocate systems 135 can identify possible gift options for Jon such as popular video games for a teen audience, sportswear, books, and so on. In some instances, some of the advocate systems 135 may have historical data on what the user has purchased for Jon on prior birthdays, which can assist these systems in further refining the choice of advertisements submitted for inclusion in the user's calendar. The historical data can be tracked by the PMS 130 and supplied in part with the user's profiles. It should be noted that the metadata transmitted with the advertisements can also instruct the calendar application of the tablet 602 to adjust the reminder option in the user's calendar entries. For example, in the case of Jon's birthday, the metadata can require that a reminder of at least one week be given to this entry so that the user has sufficient time to respond to promotional advertisements included in the event.

Similar principles can apply to anniversary events such as the one shown on December 10^{th}.

The advocate systems 135 can also provide advertisements for scheduled events such as dinners, and vacations. In these cases the advocate systems 135 can identify supplementary activities which can enhance the user's experience. For example, Ad 7 can propose possible movie theaters or plays which can follow the dinner. The advocate systems 135 can also offer coupons or discounts at the restaurant selected by the user, or propose alternative restaurants to choose from which may be of equal quality with discounted rates. As was done with Jon's birthday, the advocate systems 135 can supply advertisements with adjusted reminders to trigger the calendar event at an earlier time, thereby giving the user sufficient time to plan or make adjustments to the scheduled event.

Scheduled vacations can also be a targeted segment of the advocate systems 135. In the present illustration the user is planning a ski vacation early in the winter season. The advocate systems 135 can for example identify who is attending the vacation (user, family, friends), where the vacation is taking place, and potentially lodging information. With this information, the advocate systems 135 can identify locations with specials for ski equipment rentals near the user's lodge, specials for ski lessons, restaurants to recommend, and so on.

Popular holidays such as Christmas can also be a targeted event. The advocate systems 135 can for example determine from the profiles of the user that s/he has a spouse and young children. Knowing the age and gender of the spouse and children, the advocate systems 135 can make gift suggestions, supply coupons, discount codes, hyperlinks to direct the user to a website, and so on. The advocate systems 135 can also retrieve historical data on the user to hone in on appropriate holiday gifts.

The foregoing illustrations can be adapted for any calendar event which the user discloses by way of the tablet 602 (or other communication device) to the PMS 130 and the advocate systems 135.

Once the advertisements have been presented in step 522, the tablet 602 can proceed to step 524 to monitor the selection of a product or service promoted by the advertisement. If the user chooses to make a purchase in step 526, the tablet 602 can proceed to step 528 where it initiates a common method for performing an on-line purchase such as by supplying credit card information, or invoking a common payment system such as PayPal™. Once the PMS 130 is informed that a purchase has taken place, the PMS can generate a fee which can be directed to the advocate system 135 or entity associated with the product or service that was purchased by the user. A fee in the present context can represent any form of legal consideration which can be derived from the transaction. For instance, a fee can represent an invoice submitted to the advocate system 135 or entity. Alternatively a fee can represent a request for an agreed royalty payment.

If a purchase is not made, the user can choose to submit instead a reverse bid for the product or service promoted. That is, the user can generate a counteroffer that changes the terms originally proposed in the advertisement. The counteroffer can represent a request for a lower price or higher discount. The reverse bid can be generated by the user by manipulating functions in the user interface of the tablet 602 while responding to the advertisement selected in step 524. The reverse bid can be transmitted from the tablet 602 to the PMS 130 in step 532. The PMS 130 can inform the advocate system 135 that generated the advertisement in question of the reverse bid and await a decision in step 534. If the advocate system 135 rejects the reverse bid or provides a counteroffer to the reverse bid, the PMS 130 can inform the tablet 602 of this decision and the process can begin once more from step 530. If the reverse bid is accepted, the PMS 130 can inform the tablet 602 of the accepted reverse bid in step 536. In the same step, the PMS 130 can generate a fee directed to the advocate system 130 in question as described earlier.

Upon reviewing the aforementioned embodiments, it would be evident to an artisan with ordinary skill in the art that said embodiments can be modified, reduced, or enhanced without departing from the scope and spirit of the claims described below. Method 500 can be adapted so that the handsets 604 can perform in whole or in part the functions described above for the tablet 602. Method 500 can also be adapted to perform these tasks on any communication device including without limitation desktop computers, laptop computers, cellular phones, personal digital assistants, and so on.

Other suitable modifications can be applied to the present disclosure without departing from the scope of the claims below. Accordingly, the reader is directed to the claims section for a fuller understanding of the breadth and scope of the present disclosure.

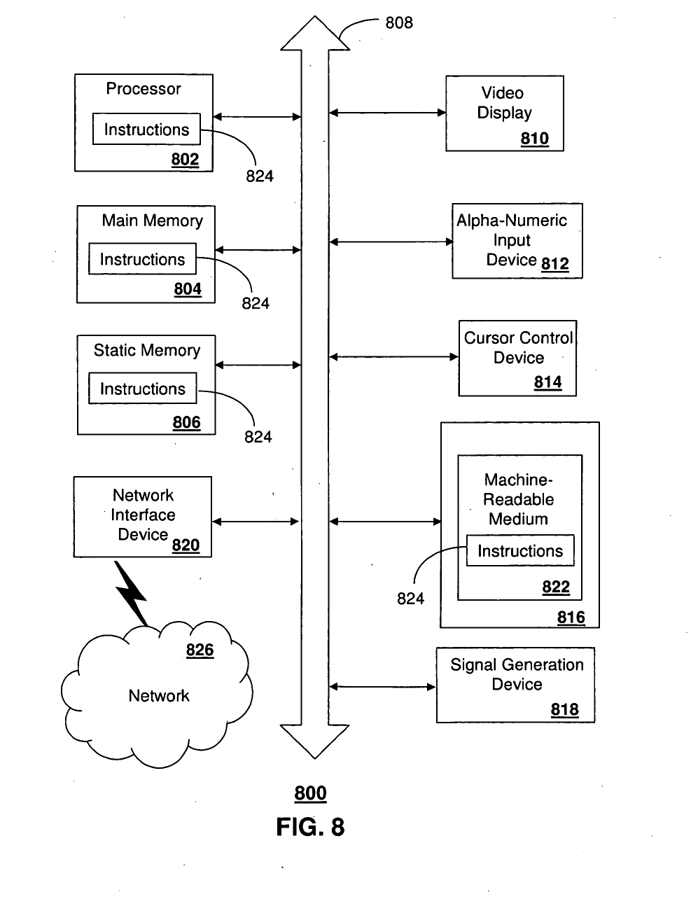

FIG. 8 depicts an exemplary diagrammatic representation of a machine in the form of a computer system 800 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU, or both)), a main memory 804 and a static memory 806, which communicate with each other via a bus 808. The computer system 800 may further include a video display unit 810 (e.g., a liquid crystal display (LCD), a flat panel, a solid state display, or a cathode ray tube (CRT)). The computer system 800 may include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 may include a machine-readable medium 822 on which is stored one or more sets of instructions (e.g., software 824) embodying any one or more of the methodologies or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system, comprising a controller to:
receive an acceptance from a user to opt into an advertisement program;
receive from the user a plurality of calendar events associated with personal information of the user;
share the plurality of calendar events with a plurality of advocates;
receive from the plurality of advocates a corresponding plurality of advertisements, each advertisement indicating an association with one of the plurality of calendar events; and
transmit to a communication device of the user the plurality of advertisements for updating the plurality of calendar events at the communication device.

2. The system of claim 1, wherein the controller is adapted to receive the acceptance of the user from one of a portal and the communication device.

3. The system of claim 1, wherein the controller is adapted to receive the plurality of calendar events from a calendar application operating in the communication device.

4. The system of claim 1, wherein the controller is adapted to receive the plurality of calendar events from an address book application operating in the communication device.

5. The system of claim 1, wherein the plurality of calendar events comprise information associated with each of a plurality of parties.

6. The system of claim 5, wherein the plurality of parties comprise at least two of the user, a sibling of the user, a parent of the user, a spouse of the user, a child of the user, a grandchild of the user, and a friend of the user.

7. The system of claim 5, wherein the information of each party comprises at least one of a description of an association to the user, a gender description, a home address, a work address, a birth date, and a wedding anniversary.

8. The system of claim 1, wherein the plurality of advertisements comprise promotions corresponding to a measure of disclosure provided in the plurality of calendar events.

9. The system of claim 1, wherein each of the plurality of advertisements promotes a product or service, and wherein the controller is adapted to:
detect a sale to the user of a product or service promoted by one of the plurality of advertisements; and
record a fee directed to the advocate or another party associated with the advertisement that promoted the product or service purchased by the user.

10. The system of claim 1, wherein the controller is adapted to:
receive from the user a counterproposal associated with a product or service promoted by one of the plurality of advertisements; and
transmit the counterproposal to the advocate or another party associated with the advertisement that promoted the product or service.

11. The system of claim 1, wherein the system operates in at least one of an Internet Protocol TV (IPTV) communication network, a cable TV communication network, a satellite TV communication network, and an IP Multimedia Subsystem (IMS) communication network.

12. The system of claim 1, wherein the controller is adapted to share at least one of a demographic profile, a psychographic profile, and a behavioral profile of the user with the plurality of advocates.

13. A communication device, comprising a controller to:
record a plurality of calendar events;
receive a plurality of advertisements, each advertisement directed to one of the plurality of calendar events,
wherein the plurality of calendar events are shared with one or more advocates, and wherein the one or more advocates generate the plurality of advertisements according to subject matter in the shared plurality of calendar events;
identify associations between the plurality of advertisements and the plurality of calendar events; and
update the recorded plurality of calendar events with the plurality of advertisements according to the identified associations.

14. The communication device of claim 13, wherein at least one of the plurality of advertisements includes a reminder, wherein the controller is adapted to update at least one of the recorded plurality of calendar events according to the reminder and the corresponding advertisement associated with the reminder.

15. The communication device of claim 14, wherein the controller is adapted to retrieve the plurality of calendar events from an address book.

16. The communication device of claim 15, wherein the plurality of events comprise information associated with each of a plurality of parties recorded in the address book.

17. The communication device of claim 16, wherein the plurality of parties comprise at least two of the user, a sibling of the user, a parent of the user, a spouse of the user, a child of the user, a grandchild of the user, and a friend of the user.

18. The communication device of claim 16, wherein the information of each party comprises at least one of a description of an association to the user, a gender description, a home address, a work address, a birth date, and a wedding anniversary.

19. The communication device of claim 13, wherein the controller is adapted to:
detect a trigger of one of the calendar events; and
present the advertisement associated with the triggered calendar event.

20. The communication device of claim 19, wherein the controller is adapted to:
detect a selection of a product or service promoted by the advertisement; and
initiate a purchase of the product or service.

21. The communication device of claim 20, wherein the controller is adapted to inform a system supplying the plurality of advertisements of the purchase.

22. The communication device of claim 19, wherein the controller is adapted to:
detect a selection of a product or service promoted by the advertisement;
receive a reverse bid for the product or service; and
transmit the reverse bid to a system that supplied the plurality of advertisements.

23. A method, comprising promoting a product or service by way of a calendar operating in a communication device of a party, wherein the party shares a plurality of calendar events with an advocate of the product or service.

24. The method of claim 23, wherein the plurality of calendar events comprise subject matter associated with each of a plurality of parties, and wherein the party shares the plurality of calendar event by way of a computing device.

25. The method of claim 24, wherein the subject matter of each party comprises at least one of a description of an association to a user of the plurality of calendar events, a gender description, a home address, a work address, a birth date, and a wedding anniversary.
